(19) United States
(12) Patent Application Publication
(10) Pub. No.: US 2026/0151287 A1
(43) Pub. Date: Jun. 4, 2026

(54) PROTECTIVE SHIELD FOR GUIDING INDIVIDUALS

(71) Applicant: Calvette Brown, Riverside, IL (US)

(72) Inventor: Calvette Brown, Riverside, IL (US)

(21) Appl. No.: 19/465,367

(22) Filed: Jan. 30, 2026

Related U.S. Application Data
(63) Continuation-in-part of application No. 16/877,486, filed on May 19, 2020, now Pat. No. 12,539,190.

(51) Int. Cl. A61H 3/06

(52) U.S. Cl. CPC A61H 3/06; A61H 2201/1638

(57) ABSTRACT

The present disclosure provides a protective shield comprising a barrier having a first major surface and a second major surface configured to block contact between a guider and a person being guided. A first handle is attached to the first major surface and configured to be placed over the shoulder of the guider. A second handle is attached to the second major surface and configured to be grasped by the person being guided. The barrier may include a rigid connection portion, with the first and second handles attached to opposite sides. The shield may be flexible, and the handles may be detachable. The barrier can be transparent, and the handles may be portions of a single adjustable strap that slides through the barrier.

### CROSS-REFERENCE TO RELATED APPLICATIONS

This application is a continuation-in-part of U.S. application Ser. No. 16/877,486, filed May 19, 2020, which is hereby incorporated by reference in its entirety.

### TECHNICAL FIELD

The present disclosure generally relates to personal protective equipment. More specifically, the present disclosure relates to a protective shield that prevents direct contact between a guider and a person being guided.

### BACKGROUND

The sighted guide or human guide technique is a widely used method for assisting individuals who are blind, visually impaired, or otherwise in need of physical guidance while walking. This technique involves the person being guided grasping the arm of the guide just above the elbow, allowing for safe and efficient travel in various environments. The human guide approach enables individuals with visual impairments or other disabilities to navigate unfamiliar spaces with greater confidence and independence.

In recent years, there has been increased awareness of the potential for disease transmission through person-to-person contact. This has led to a growing interest in methods for maintaining physical distance between individuals, even in situations where close proximity would traditionally be expected. The healthcare industry, in particular, has seen a focus on reducing unnecessary physical contact between caregivers and patients to minimize the risk of spreading infections.

Existing personal protective equipment (PPE) typically focuses on creating barriers between an individual and their environment, such as face masks, gloves, and gowns. However, there are limited options for PPE specifically designed to maintain separation between two people who need to remain in close proximity for functional purposes, such as during guided walking.

The traditional human guide technique involves direct physical contact between the guide and the person being guided. While this method is effective for navigation, it does not account for situations where maintaining physical separation is desired or required. There is a need for solutions that can provide the benefits of the human guide technique while also addressing concerns about disease transmission and personal space.

As society continues to adapt to changing health and safety considerations, there is an opportunity to explore new approaches to assistive technologies and guiding techniques. Innovations in this area could potentially benefit not only individuals with visual impairments but also elderly individuals, those with mobility challenges, and others who may require physical guidance in various settings.

### SUMMARY

Embodiments of the present disclosure are directed to a shield/barrier that can protect both the guider and the person being guided from exposure to viruses and bacteria that could be transmitted through direct person-to-person contact. The shield can have varying shapes, sizes, materials, and translucency (e.g., transparent, semi-transparent, or opaque), and include extroverted collapsible handles and/or straps affixed to or detachable from the shield. The shield can include a cuff (with or without an additional handle). The handles and/or straps can be detachable or molded on one or multiple sides of the shield, such that when the handle/strap is placed over the shoulder of the guider, the shield acts as a no-contact barrier between the guider and the person who is being guided. The person who is being guided can grasp the handle, the strap, or the cuff so that the guider can safely guide the guidee to the destination point. The protective shield can be used while assisting the elderly, a disabled person, an individual who is blind/visually impaired, or any person who needs assistance while walking.

The present disclosure provides a protective shield comprising a barrier having a first major surface and a second major surface and configured to block contact between a guider and a person being guided, a first handle attached to the first major surface and configured to be placed over the shoulder of the guider, and a second handle attached to the second major surface and configured to be grasped by the person who is being guided.

The present disclosure provides a protective shield comprising a barrier having a first major surface and a second major surface and configured to block contact between a guider and a person being guided, a first handle attached to the first major surface and configured to be placed over the shoulder of the guider, and a second handle attached to the second major surface and configured to be grasped by the person who is being guided, wherein the shield further comprises a rigid connection portion, wherein the first handle and the second handle are attached to the opposite sides of the rigid connection portion. The protective shield can be a flexible shield.

One or more embodiments described herein relate to a protective shield comprising a barrier having a first major surface and a second major surface and configured to block contact between a guider and a person being guided, a first handle attached to the first major surface and configured to be placed over the shoulder of the guider, and a second handle attached to the second major surface and configured to be grasped by the person who is being guided, wherein the first handle and the second handle are detachable.

One or more embodiments described herein relate to a protective shield comprising a barrier having a first major surface and a second major surface and configured to block contact between a guider and a person being guided, a first handle attached to the first major surface and configured to be placed over the shoulder of the guider, and a second handle attached to the second major surface and configured to be grasped by the person who is being guided, wherein the shield further comprises a rigid connection portion, wherein the first handle and the second handle are attached to the opposite sides of the rigid connection portion, wherein the first handle and the second handle are detachable.

The present disclosure provides a protective shield comprising a barrier having a first major surface and a second major surface and configured to block contact between a guider and a person being guided, a first handle attached to the first major surface and configured to be placed over the shoulder of the guider, and a second handle attached to the second major surface, wherein the second handle is an inverted handle which can be grasped by the person who is being guided. The protective shield can be a transparent shield.

The present disclosure also provides a protective shield comprising a barrier having a first major surface and a second major surface and configured to block contact between a guider and a person being guided, a first handle attached to the first major surface and configured to be placed over the shoulder of the guider, and a second handle attached to the second major surface and configured to be grasped by the person who is being guided, wherein the first handle and the second handle are two portions of a single strap that slides through the barrier so that the strap acts as the handle for both the first surface of the barrier and the second surface of the barrier. The protective shield can be a transparent shield.

One or more embodiments described herein relate to a protective shield comprising a barrier having a first major surface and a second major surface and configured to block contact between a guider and a person being guided, and a cuff attached to the barrier, wherein the cuff is configured to expand around the arm of a guider and positioned with respect to the barrier such that the person who is being guided grasps the cuff instead of grasping the guider's arm. The cuff can be detachable.

Also provided herein is a protective shield comprising a barrier having a first major surface and a second major surface and configured to block contact between a guider and a person being guided, and a cuff attached to the barrier, wherein the cuff is configured to expand around the arm of a guider and positioned with respect to the barrier such that the person who is being guided grasps the cuff instead of grasping the guider's arm, wherein the shield further comprises a handle. The handle can be attached to either side of the barrier. The handle can be an inverted handle. The shield can be a transparent shield.

The embodiments disclosed herein are intended to be illustrative of the invention. The present invention is not limited to these embodiments. Other embodiments and modifications will be apparent to the skilled person. For example, the handles and straps can be affixed to the shield, in a manner other than as described. All such embodiments and modification fall within the scope of the present invention, which is limited only by the appended claims and equivalents thereof.

### BRIEF DESCRIPTION OF THE DRAWINGS

Various features and advantages of the invention will be understood more completely when considered in connection with the accompanying drawings (which are not necessarily drawn to scale), wherein:

FIG. 1 depicts a front perspective view of a shield with two detachable handles, according to an embodiment. The shield includes a rigid connection portion and the handles are attached to the opposite sides of the rigid connection portion.

FIG. 2 depicts a back perspective view of the shield of FIG. 1. In FIG. 2, a guider is wearing the shield of FIG. 1.

FIG. 3 depicts a front perspective view of a shield with two handles over the shoulder of a guider, according to an embodiment. There is no rigid connection portion between the handles.

FIG. 4 depicts a shield, wherein one strap slides through the shield, according to an embodiment. That is, the strap slides through the shield so that the same strap acts as a handle for both sides of the shield.

FIG. 5 depicts a back perspective view of the shield of FIG. 4, over the shoulder of a guider.

FIG. 6 depicts a front perspective view of the shield of FIG. 4, over the shoulder of a guider.

FIG. 7 depicts a front perspective of a shield attached to a handle and a cuff, according to an embodiment. The cuff is configured to expand around the arm of a guider.

FIG. 8 depicts a back perspective view of the shield of FIG. 7, over the shoulder of a guider.

FIG. 9 depicts a front perspective view of the shield of FIG. 7, over the shoulder of a guider.

FIG. 10 depicts a front perspective view of a shield attached to a cuff, according to an embodiment. The shield does not include a handle.

FIG. 11 depicts a shield in a collapsed state, according to an embodiment.

FIG. 12 depicts the shield of FIG. 11 in an expanded state.

FIG. 13 depicts a shield in a collapsed state, according to an embodiment.

FIG. 14 depicts the shield of FIG. 13 in an expanded state.

FIG. 15 depicts a portion of the shield of FIG. 14.

FIG. 16 depicts a front perspective view of a shield in a collapsed state, according to an embodiment.

FIG. 17 depicts a right side perspective view of the shield of FIG. 16, in a collapsed state.

FIG. 18 depicts a front perspective view of the shield of FIG. 16, in an expanded state.

FIG. 19 depicts a right side perspective view of the shield of FIG. 16, in an expanded state.

FIG. 20 depicts a front perspective view of a shield in a collapsed state, according to an embodiment.

FIG. 21 depicts a front perspective view of the shield of FIG. 20, in an expanded state.

FIG. 22 depicts a shield in a collapsed state, according to an embodiment.

FIG. 23 depicts the shield of FIG. 22, in an expanded state.

FIG. 24 depicts a portion of the shield of FIG. 23.

FIG. 25 depicts a shield in a collapsed state, according to an embodiment.

FIG. 26 depicts a front view of the shield of FIG. 25, in an expanded state.

FIG. 27 depicts a front perspective view of the shield of FIG. 25, in an expanded state.

FIG. 28 depicts a shield with a handle in a collapsed state, according to an embodiment.

FIG. 29 depicts the shield of FIG. 28, with the handle in an expanded state.

FIG. 30 depicts a front perspective view of the shield of FIG. 28, with the handle in an expanded state.

### DETAILED DESCRIPTION OF THE DISCLOSURE

Embodiments of the present disclosure relate to a protective shield as a barrier between a guider and a person being guider. Unless defined otherwise, all technical and scientific terms used herein have the same meaning as commonly understood by one of ordinary skill in the art to which the disclosure pertains. Although any methods and materials similar or equivalent to those described herein can be used in the practice for testing of the present disclosure, the preferred materials and methods are described herein.

In the description of various embodiments, expressions such as “first,” “second,” may modify various components of the embodiments, but do not limit the components. Said expressions do not limit the order and/or importance of the components.

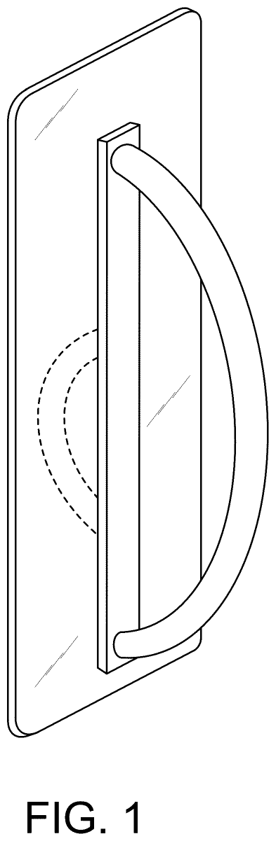

FIG. 1 depicts a shield 2 including a barrier 4, a semi-rigid or a rigid connection portion 6, and two detachable handles 8. The handles 8 are attached to the opposite sides of the barrier 4. One handle 8 is to be placed over the shoulder of the guider and the other handle 8 is to be grasped by the person who is being guided. The shield 2 blocks the contact between a guider and a person being guided. Both handles 8 are detachable. The barrier 4, for example, can be prepared using a clear plastic, a fiberglass, a rigid plexi-glass, a flexible plexi-glass, or a similar suitable material known to those of ordinary skill in the art.

FIG. 1 illustrates a front perspective view of a protective shield. The shield includes a barrier having a first major surface and a second major surface, configured to block contact between a guider and a person being guided. The barrier appears to be a flat panel with rounded corners. A curved handle is attached to the barrier, designed to be grasped by either the guider or the person being guided. The handle has a semi-circular shape and extends outward from the barrier surface. A dotted line pattern visible on the barrier suggests a potential mounting or connection area for the handle attachment. The barrier appears to have a slim profile and could be made of transparent or translucent material to allow visibility between the guider and guided person while maintaining physical separation. The overall design provides a simple yet functional approach to creating a protective barrier between two individuals during guided assistance.

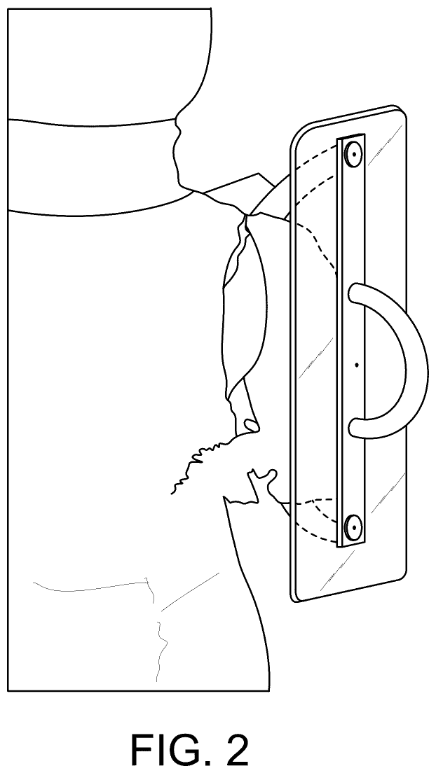

FIG. 2 depicts a back perspective view of the shield 2 shown in FIG. 1. In FIG. 2, one of the handles 8 is being grasped by the guider. The second handle 8 is to be grasped by the person who is being guided. The shield 2 blocks contact between the guider and the person being guided.

FIG. 2 illustrates a back perspective view of a protective shield device. The shield comprises a flat barrier panel with a handle attached to one side. The barrier appears to be a rectangular panel designed to create separation between individuals. The handle has a curved, ergonomic design and extends outward from the barrier surface. The handle mounting area is indicated by dotted lines on the barrier, showing where it connects to the main panel. The shield appears to be designed for providing a protective barrier while maintaining a slim profile. The barrier panel could be made of transparent or translucent material to allow visibility between users while maintaining physical separation. The overall configuration enables the shield to be held and positioned between a guide and the person being guided to prevent direct physical contact between them.

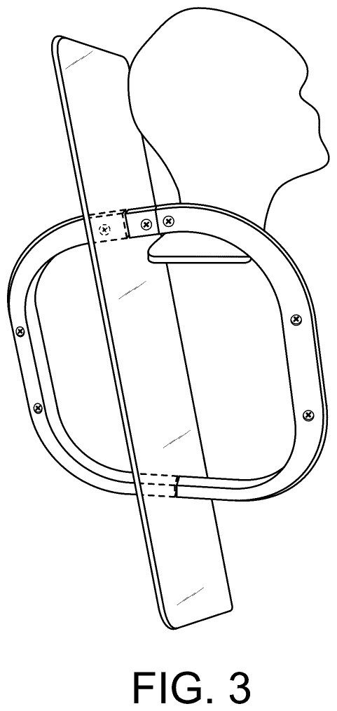

FIG. 3 depicts a front perspective view of a shield 22 with two handles 28 over the shoulder of a guider, according to another embodiment. The handles 28 are attached to the opposite sides of a barrier 24. One handle 28 is to be placed over the shoulder of the guider and the other handle 28 is to be grasped by the person who is being guided. The shield 22 blocks the contact between a guider and a person being guided. Both handles 28 are detachable. The shield of FIG. 3 does not include a semi-rigid or a rigid connection portion between the handles (e.g., semi-rigid or rigid connection portion 6 between handles 8 in the shield 2 shown in FIGS. 1 and 2).

FIG. 3 illustrates a front perspective view of a protective shield designed to prevent direct contact between a guider and a person being guided. The shield comprises a barrier having a rounded rectangular shape with a curved handle configuration. The handle forms an oval or racetrack-shaped loop that extends through the barrier, with portions protruding from both the front and back surfaces of the barrier. The handle is designed to be placed over the shoulder of the guider on one side while allowing the person being guided to grasp the opposite side. The barrier appears to be a flat panel that creates separation between the guider and guided person. The design provides a simple yet functional approach to maintaining physical distance between individuals during guided assistance, while the curved handle configuration enables comfortable gripping and proper positioning of the shield. The barrier could be constructed of transparent or translucent material to allow visibility between users while maintaining physical separation.

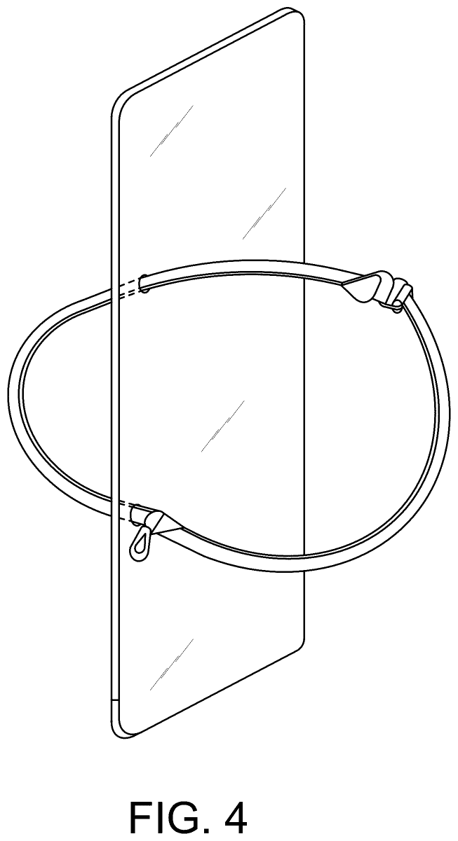

FIG. 4 depicts a shield including a barrier and two handles, where one strap slides through the shield, according to an embodiment. That is, the strap slides through the shield so that the same strap acts as a handle for both sides of the shield depicts a shield. The shield is rigid or semi-rigid, and the handles are attached to the barrier. The shield blocks contact between the guider and the person being guided.

FIG. 4 illustrates a perspective view of a protective shield device designed to create a barrier between a guider and a person being guided. The shield comprises a flat, rectangular barrier panel with rounded corners and edges. A continuous strap or handle forms a loop that passes through the barrier, with portions of the loop extending from both the front and back surfaces of the barrier. The strap is configured to slide through openings in the barrier, allowing it to function as a handle on both sides-one side for placement over the guider's shoulder and the other side for grasping by the person being guided. The barrier appears to have a slim profile and could be constructed of transparent or translucent material to maintain visibility between users while providing physical separation. The design provides a straightforward approach to maintaining distance between individuals during guided assistance, with the sliding strap mechanism offering flexibility in handle positioning and use.

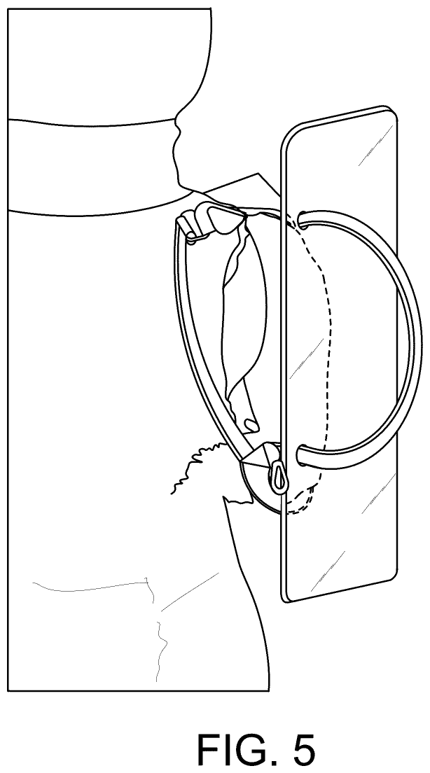

FIGS. 5 and 6 depict a shield, wherein one strap slides through the barrier, wherein the guider's handle is being grasped by the guider. The second handle is to be grasped by the person who is being guided. The shield is rigid or semi-rigid, and the handles are attached to the barrier. The shield blocks contact between the guider and the person being guided.

FIG. 5 illustrates a back perspective view of a protective shield designed to create a barrier between a guider and a person being guided. The shield comprises a flat barrier panel with a continuous strap or handle that forms a loop passing through the barrier. The strap extends from both the front and back surfaces of the barrier, with one portion configured to be placed over the shoulder of the guider while the other portion is designed to be grasped by the person being guided. The barrier appears to have a slim profile and could be constructed of transparent or translucent material to maintain visibility between users while providing physical separation. The strap appears to slide through openings in the barrier, allowing for adjustable positioning of the handle portions. The overall design provides a straightforward approach to maintaining distance between individuals during guided assistance, with the continuous strap mechanism offering flexibility in handle positioning and use.

FIG. 6 illustrates a front perspective view of a protective shield designed to create a barrier between a guider and a person being guided. The shield comprises a flat barrier panel with a continuous strap or handle that forms a loop passing through the barrier. The strap extends from both the front and back surfaces of the barrier, with one portion configured to be placed over the shoulder of the guider while the other portion is designed to be grasped by the person being guided. The barrier appears to have a slim profile and could be constructed of transparent or translucent material to maintain visibility between users while providing physical separation. The strap appears to slide through openings in the barrier, allowing for adjustable positioning of the handle portions. The overall design provides a straightforward approach to maintaining distance between individuals during guided assistance, with the continuous strap mechanism offering flexibility in handle positioning and use.

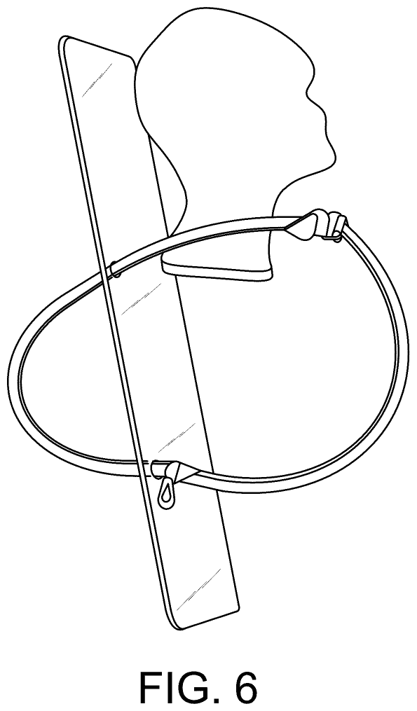

FIG. 7 depicts a shield including a barrier, a handle, and a cuff. The handle can be on either side of the shield. The cuff is configures to expand around the arm of a guider. The person who is going to be guided would grasp the cuff instead of grasping the guider's arm. The cuff is adjustable. The cuff is made of a rigid or a flexible material. The shield blocks contact between the guider and the person being guided.

FIG. 7 illustrates a front perspective view of a protective shield designed to create a barrier between a guider and a person being guided. The shield comprises a flat, rectangular barrier panel with rounded corners and edges. A cylindrical cuff element is attached to one edge of the barrier, configured to expand around the arm of a guider. The cuff appears to be designed for the person being guided to grasp instead of directly holding the guider's arm. A curved handle extends from the barrier surface, providing an additional gripping point. The barrier appears to have a slim profile and could be constructed of transparent or translucent material to maintain visibility between users while providing physical separation. The design integrates both a cuff and handle mechanism to facilitate guided assistance while maintaining appropriate physical distance between individuals. The overall configuration provides multiple options for positioning and use, with the cuff offering a secure grip point for the person being guided while the handle allows for proper positioning of the shield.

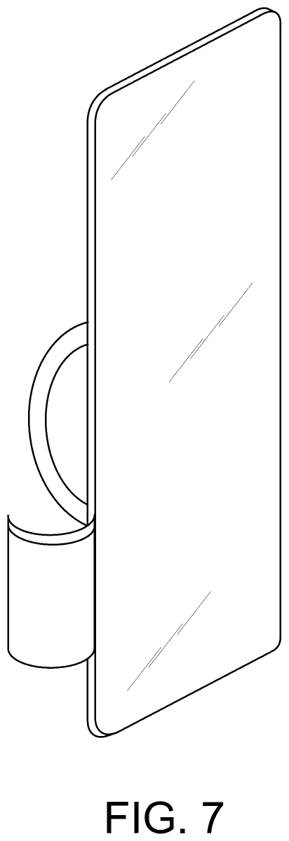

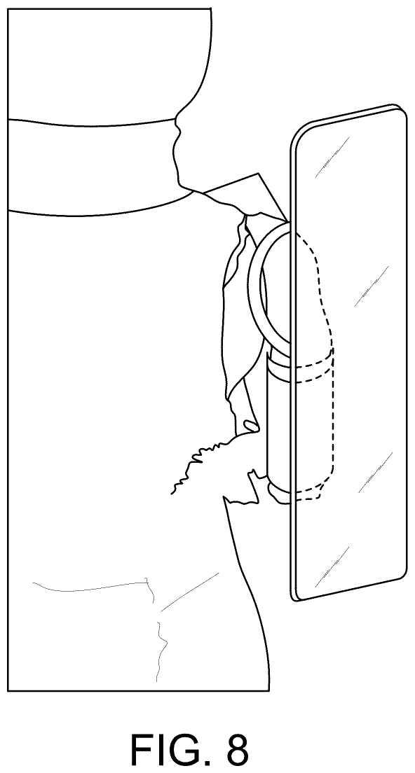

FIG. 8 depicts a shield including a barrier, a handle, and a cuff. The cuff is attached to the barrier and is worn around the upper art of the guider, wherein the person who is being guided can grasps the cuff instead of grasping the guider's arm. The shield blocks contact between the guider and the person being guided.

FIG. 8 illustrates a back perspective view of a protective shield designed to create a barrier between a guider and a person being guided. The shield comprises a flat barrier panel with rounded corners and edges. A cylindrical cuff element is attached to one edge of the barrier, configured to expand around the arm of a guider. The cuff appears to be positioned such that a person being guided can grasp it instead of directly holding the guider's arm. The barrier appears to have a slim profile and could be constructed of transparent or translucent material to maintain visibility between users while providing physical separation. The design incorporates the cuff mechanism to facilitate guided assistance while maintaining appropriate physical distance between individuals. The overall configuration allows for secure positioning around the guider's arm while providing a dedicated gripping point for the person being guided through the cuff element.

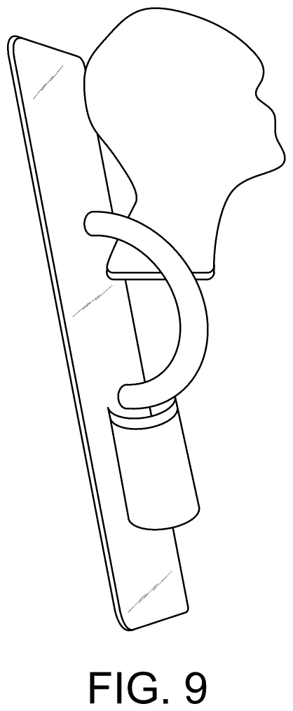

FIG. 9 depicts a shield including a barrier, a handle, and a cuff, wherein the shield is placed over the shoulder of the guider. The handle is attached to the guider's side of the barrier. The guider can grasp the handle to keep the shield in place, while the person being guided grasps the cuff. The shield blocks contact between the guider and the person being guided.

FIG. 9 illustrates a front perspective view of a protective shield designed to create a barrier between a guider and a person being guided. The shield comprises a flat barrier panel with rounded corners and edges. A cylindrical cuff element is attached to one edge of the barrier, configured to expand around the arm of a guider. A curved handle extends from the barrier surface on the guider's side, providing a gripping point for maintaining the shield's position. The barrier appears to have a slim profile and could be constructed of transparent or translucent material to maintain visibility between users while providing physical separation. The design integrates both the cuff and handle mechanisms to facilitate guided assistance while maintaining appropriate physical distance between individuals. The cuff is positioned such that a person being guided can grasp it instead of directly holding the guider's arm, while the handle allows the guider to stabilize and position the shield.

FIG. 10 depicts a shield including a barrier and a cuff. There is no handle attached to the barrier. The person being guided can grasp the cuff. The shield blocks contact between the guider and the person being guided. FIG. 10 illustrates a front perspective view of a protective shield designed to create a barrier between a guider and a person being guided. The shield comprises a flat barrier panel with rounded corners and edges. A cylindrical cuff element is attached to one edge of the barrier, configured to expand around the arm of a guider. The cuff appears to be positioned such that a person being guided can grasp it instead of directly holding the guider's arm. Unlike other embodiments, this design does not include an additional handle component. The barrier appears to have a slim profile and could be constructed of transparent or translucent material to maintain visibility between users while providing physical separation. The design provides a straightforward approach to maintaining distance between individuals during guided assistance, with the cuff mechanism offering a secure gripping point for the person being guided while eliminating direct physical contact with the guider's arm.

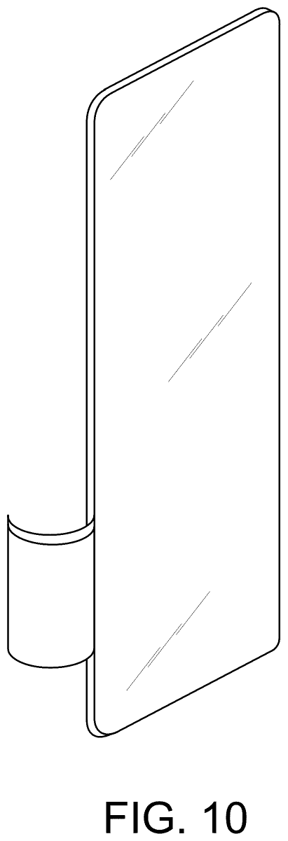

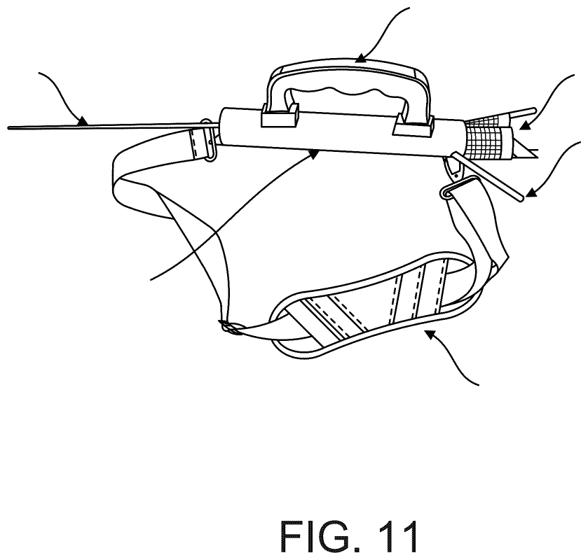

FIG. 11 depicts a shield in a collapsed state, according to an embodiment. FIG. 11 illustrates a perspective view of a protective shield in a collapsed state. The shield comprises a barrier having a first major surface and a second major surface, configured to block contact between a guider and a person being guided. A handle is attached to the barrier and appears to be designed for placement over the shoulder of a guider. The barrier appears to be in a folded or collapsed configuration, allowing for compact storage when not in use. The handle maintains its curved shape even in the collapsed state, suggesting it is made of a rigid or semi-rigid material. The overall design provides a portable and collapsible solution for maintaining physical separation between individuals during guided assistance, while offering convenient storage capabilities when not in use. The barrier could be constructed of flexible material that enables folding or collapsing while maintaining its protective functionality when expanded.

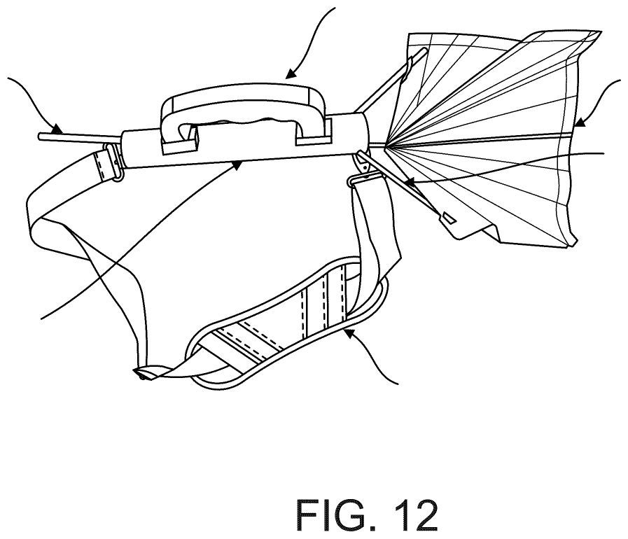

FIG. 12 depicts the shield of FIG. 11 in an expanded state. FIG. 12 illustrates a perspective view of a protective shield in an expanded state. The shield comprises a barrier having a first major surface and a second major surface, configured to block contact between a guider and a person being guided. The barrier appears to be constructed with a fan-like design that can expand outward from a central point. The expanded configuration creates a wider protective surface area compared to its collapsed state. A curved handle extends from one side of the barrier, designed to be placed over the shoulder of a guider. The barrier includes multiple panels that unfold in a radial pattern, similar to how a handheld fan operates. The expanded configuration provides a substantial barrier surface while maintaining a slim profile. The design allows for convenient storage when collapsed while offering effective physical separation between individuals when expanded. The barrier could be constructed of flexible material that enables folding while maintaining rigidity when expanded.

FIG. 13 depicts a shield in a collapsed state, according to an embodiment. FIG. 13 illustrates a perspective view of a protective shield in a collapsed state. The shield comprises a barrier having a first major surface and a second major surface, configured to block contact between a guider and a person being guided. A strap or handle extends from the barrier, designed to be placed over the shoulder of a guider or grasped by a person being guided. The barrier appears to be in a folded or collapsed configuration, allowing for compact storage when not in use. The design provides a portable and collapsible solution for maintaining physical separation between individuals during guided assistance, while offering convenient storage capabilities when not in use. The barrier could be constructed of flexible material that enables folding or collapsing while maintaining its protective functionality when expanded.

FIG. 14 depicts the shield of FIG. 13 in an expanded state.

FIG. 15 depicts a portion of the shield of FIG. 14.

FIG. 14 illustrates a perspective view of a protective shield in an expanded state. The shield comprises a barrier having a first major surface and a second major surface, configured to block contact between a guider and a person being guided. A strap or handle extends from the barrier, designed to be placed over the shoulder of a guider or grasped by a person being guided. The shield includes a rigid connection portion 1423 that provides structural support. The barrier appears to be in an expanded configuration, creating a protective surface area between individuals. The design provides a solution for maintaining physical separation between individuals during guided assistance. The barrier could be constructed of flexible or rigid material while maintaining its protective functionality.

FIG. 15 illustrates a detailed view of a portion of the shield shown in FIG. 14, specifically highlighting the rigid connection portion 1423. This view provides a closer look at the structural details and configuration of how the rigid connection portion 1423 integrates with the barrier design.

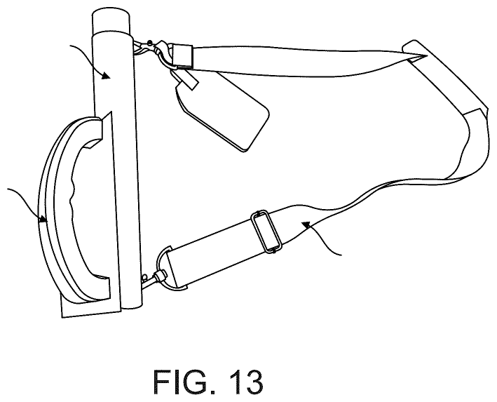

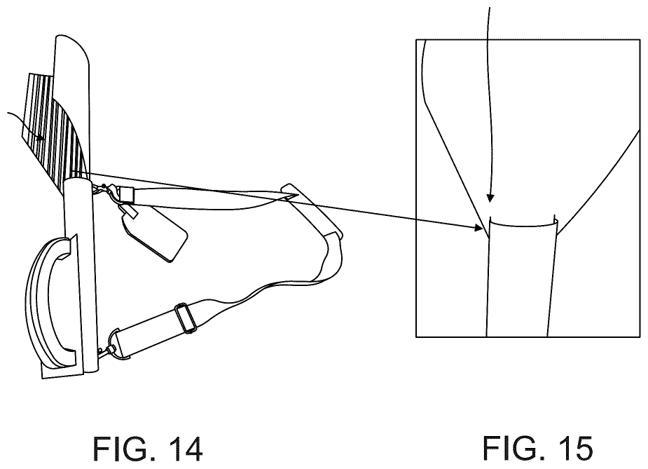

FIG. 16 depicts a front perspective view of a shield in a collapsed state, according to an embodiment. FIG. 17 depicts a right side perspective view of the shield of FIG. 16, in a collapsed state.

FIGS. 16 and 17 illustrate front and right side perspective views, respectively, of a protective shield in a collapsed state. The shield comprises a barrier having a first major surface and a second major surface configured to block contact between a guider and a person being guided. The barrier appears to be constructed with a folding mechanism that allows it to collapse into a more compact configuration. The shield includes a curved handle or strap component that maintains its shape even when the barrier is collapsed. The collapsed configuration enables convenient storage and transport of the shield when not in use. The barrier could be constructed of flexible material that enables folding while maintaining its protective functionality when expanded.

The design shows a simple yet functional approach to providing a collapsible protective barrier between individuals during guided assistance. The folding mechanism appears to allow the barrier to compress vertically while maintaining the handle's accessibility. The overall configuration provides a portable solution that can be easily stored and deployed as needed.

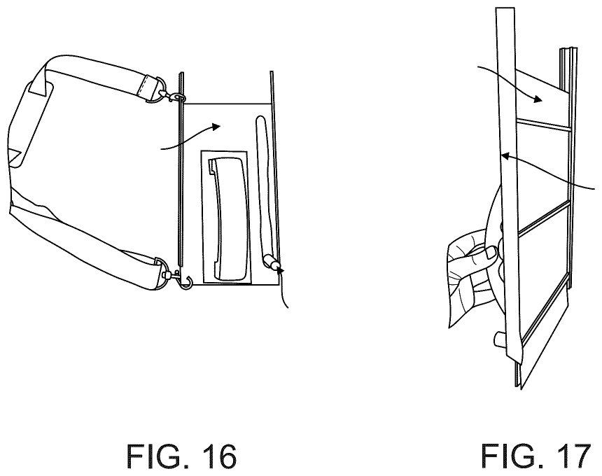

FIG. 18 depicts a front perspective view of the shield of FIG. 16, in an expanded state. FIG. 19 depicts a right side perspective view of the shield of FIG. 16, in an expanded state.

FIG. 18 illustrates a front perspective view of a protective shield in an expanded state. The shield comprises a barrier having a first major surface and a second major surface configured to block contact between a guider and a person being guided. The barrier appears to be constructed with a folding or expanding mechanism that allows it to extend vertically from a collapsed state. A curved handle extends from one side of the barrier, designed to be placed over the shoulder of a guider or grasped by a person being guided. The expanded configuration creates a protective surface area between individuals while maintaining a slim profile. The barrier could be constructed of flexible or rigid material that enables expansion and collapse while maintaining its protective functionality.

FIG. 19 illustrates a right side perspective view of the shield shown in FIG. 18 in its expanded state. This view shows the profile of the expanded barrier and demonstrates how the curved handle extends from the barrier surface. The side view highlights the vertical extension of the barrier and its relationship to the handle component. The design provides a straightforward approach to maintaining physical separation between individuals during guided assistance.

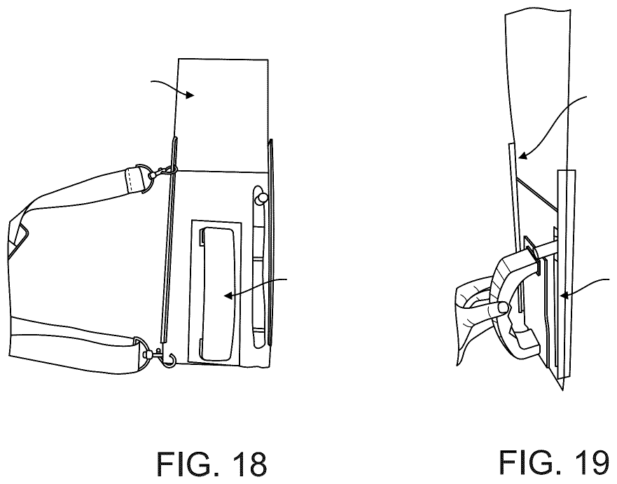

FIG. 20 depicts a front perspective view of a shield in a collapsed state, according to an embodiment. FIG. 20 illustrates a front perspective view of a protective shield in a collapsed state. The shield comprises a barrier having a first major surface and a second major surface configured to block contact between a guider and a person being guided. The barrier appears to be constructed with a folding mechanism that allows it to collapse into a more compact configuration. Two curved handles or straps extend from opposite sides of the barrier, designed to be placed over the shoulder of a guider on one side and grasped by the person being guided on the other side. The handles maintain their curved shape even when the barrier is collapsed. The collapsed configuration enables convenient storage and transport of the shield when not in use. The barrier could be constructed of flexible material that enables folding while maintaining its protective functionality when expanded. The design provides a portable solution for maintaining physical separation between individuals during guided assistance.

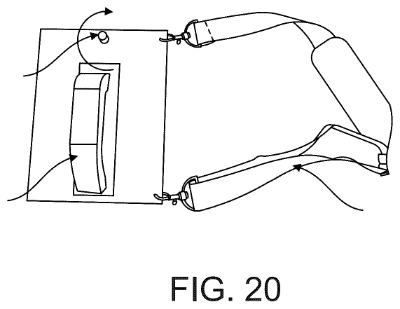

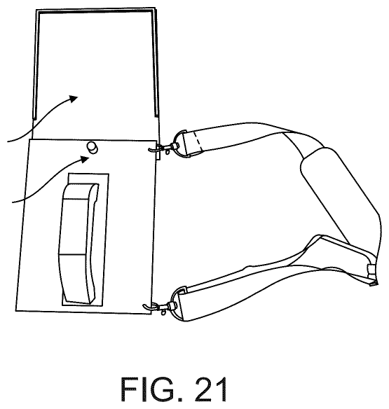

FIG. 21 depicts a front perspective view of the shield of FIG. 20, in an expanded state. FIG. 21 illustrates a front perspective view of a protective shield in an expanded state. The shield comprises a barrier having a first major surface and a second major surface configured to block contact between a guider and a person being guided. The barrier appears to be constructed with a folding or expanding mechanism that allows it to extend from a collapsed state (as shown in FIG. 20) to an expanded state. Two curved handles or straps extend from opposite sides of the barrier, designed to be placed over the shoulder of a guider on one side and grasped by the person being guided on the other side. The handles maintain their curved shape in both collapsed and expanded states. The expanded configuration creates a protective surface area between individuals while maintaining a slim profile. The barrier could be constructed of flexible or rigid material that enables expansion and collapse while maintaining its protective functionality. The design provides a solution for maintaining physical separation between individuals during guided assistance.

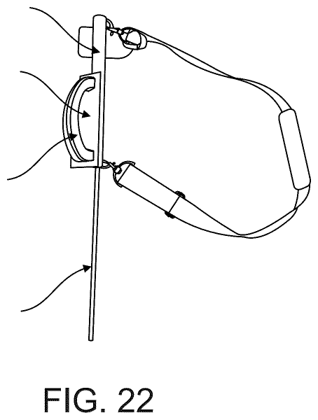

FIG. 22 depicts a shield in a collapsed state, according to an embodiment. FIG. 22 illustrates a perspective view of a protective shield in a collapsed state. The shield comprises a barrier having a first major surface and a second major surface configured to block contact between a guider and a person being guided. The barrier appears to be constructed with a folding mechanism that allows it to collapse into a more compact configuration. A curved handle or strap extends from the barrier, designed to be placed over the shoulder of a guider or grasped by a person being guided. The collapsed configuration enables convenient storage and transport of the shield when not in use. The barrier could be constructed of flexible material that enables folding while maintaining its protective functionality when expanded. The design provides a portable solution for maintaining physical separation between individuals during guided assistance.

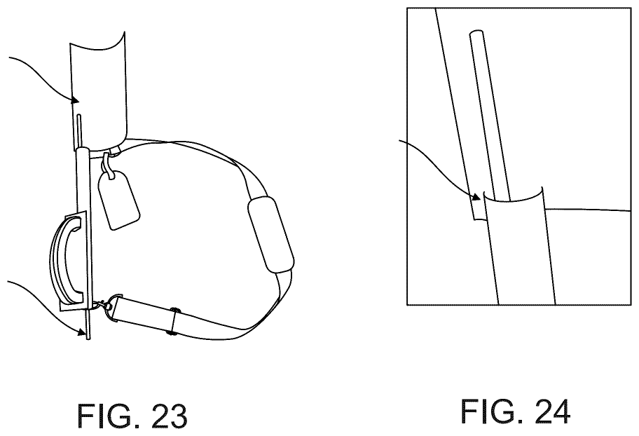

FIG. 23 depicts the shield of FIG. 22, in an expanded state. FIG. 23 illustrates a perspective view of a protective shield in an expanded state. The shield comprises a barrier having a first major surface and a second major surface configured to block contact between a guider and a person being guided. The shield barrier 2023 appears to be constructed with a folding or expanding mechanism that allows it to extend vertically from a collapsed state (as shown in FIG. 22). A curved handle extends from one side of the barrier 2023, designed to be placed over the shoulder of a guider or grasped by a person being guided. The expanded configuration creates a protective surface area between individuals while maintaining a slim profile. The barrier 2023 could be constructed of flexible or rigid material that enables expansion and collapse while maintaining its protective functionality. The handle maintains its curved shape in both collapsed and expanded states, providing a consistent gripping point regardless of the barrier's configuration.

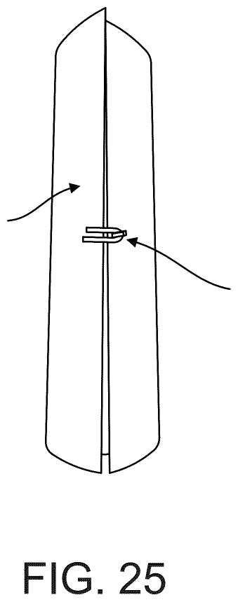

FIG. 24 depicts a portion of the shield of FIG. 23. FIG. 25 depicts a shield in a collapsed state, according to an embodiment. FIG. 25 illustrates a perspective view of a protective shield in a collapsed state. The shield comprises a barrier having a first major surface and a second major surface configured to block contact between a guider and a person being guided. The barrier appears to be constructed with a folding mechanism that allows it to collapse vertically into a more compact configuration. A curved handle extends from one side of the barrier, designed to be placed over the shoulder of a guider or grasped by a person being guided. The handle maintains its curved shape even when the barrier is collapsed. The collapsed configuration enables convenient storage and transport of the shield when not in use. The barrier could be constructed of flexible material that enables folding while maintaining its protective functionality when expanded. The design provides a portable solution for maintaining physical separation between individuals during guided assistance.

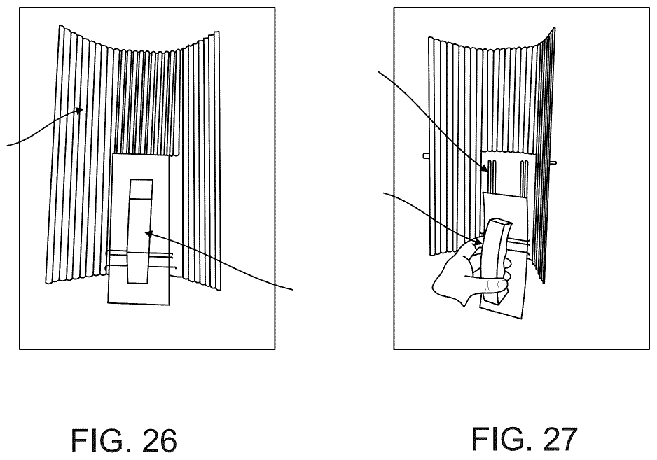

FIG. 26 depicts a front view of the shield of FIG. 25, in an expanded state. FIG. 27 depicts a front perspective view of the shield of FIG. 25, in an expanded state.

FIGS. 26 and 27 illustrate front and front perspective views, respectively, of a protective shield in an expanded state. The shield comprises a barrier having a first major surface and a second major surface configured to block contact between a guider and a person being guided. The vertical barrier 2223 appears to be constructed with vertical slats or panels that can extend upward from a collapsed state. The vertical barrier 2223 creates a protective surface area between individuals while maintaining a slim profile when expanded. The barrier design allows the vertical slats to collapse downward for storage and extend upward for use. The vertical barrier 2223 could be constructed of flexible or rigid material that enables expansion and collapse while maintaining its protective functionality. The design provides a solution for maintaining physical separation between individuals during guided assistance, with the vertical slat configuration offering both expandability and stability when deployed.

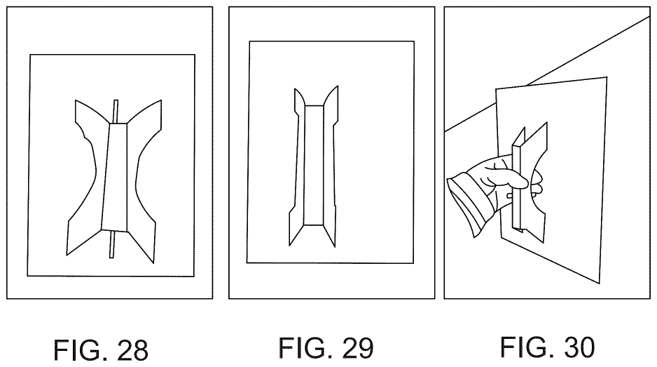

FIG. 28 depicts a shield with a handle in a collapsed state, according to an embodiment. FIG. 29 depicts the shield of FIG. 28, with the handle in an expanded state. FIG. 30 depicts a front perspective view of the shield of FIG. 28, with the handle in an expanded state.

FIG. 28, FIG. 29, and FIG. 30 illustrate sequential views of a protective shield 2923 transitioning from a collapsed state to an expanded state.

FIG. 28 shows a front view of the protective shield 2923 in a collapsed state. The protective shield 2923 comprises a barrier having a butterfly-wing shaped configuration with a central vertical portion. The barrier appears to be constructed with a folding mechanism that allows it to maintain a compact profile when collapsed.

FIG. 29 depicts the protective shield 2923 in an expanded state, showing how the butterfly-wing shaped barrier extends outward from its central vertical portion. The expanded configuration creates a wider protective surface area compared to its collapsed state while maintaining a slim profile.

FIG. 30 illustrates a front perspective view of the protective shield 2923 in its fully expanded state, with a hand shown grasping one side of the barrier. The expanded barrier creates a protective surface between individuals while providing gripping areas on both sides. The barrier appears to be designed to allow for easy transition between collapsed and expanded states while maintaining structural stability when deployed.

In some cases, a protective shield may have a butterfly-wing shaped configuration. The protective shield may be designed to transition between a collapsed state and an expanded state. When in the collapsed state, the collapsed shield may maintain a compact profile, facilitating easy storage and transport.

The protective shield may include a central vertical portion from which two wing-like sections extend. These wing-like sections may be configured to fold inward towards the central portion when the protective shield is in the collapsed state. In some implementations, the collapsed shield may incorporate a rigid connection portion to provide structural support and stability.

When transitioning to the expanded state, the wing-like sections of the protective shield may unfold outward from the central vertical portion. This expansion may create a wider protective surface area compared to the collapsed state. The shield barrier formed by the expanded wing-like sections may effectively block contact between a guider and a person being guided while maintaining a slim profile.

In some cases, the protective shield may have the capacity to thread a connector to another unit, creating a chain-like configuration. This feature may allow multiple protective shields to be linked together, potentially extending the protective barrier or accommodating multiple individuals in a guided group.

The protective shield may incorporate connecting parts to link units from one unit to the next. These connecting parts may be designed to securely join adjacent protective shields while allowing for easy separation when needed. In some implementations, the connecting parts may be integrated into the edges of the wing-like sections, enabling a seamless connection between multiple units.

The butterfly-wing shaped configuration of the protective shield may offer advantages in terms of portability and versatility. When collapsed, the protective shield may be easily stored or carried. When expanded, the protective shield may provide a substantial barrier surface while maintaining flexibility in positioning and use.

In some cases, the protective shield may be constructed using various materials to suit different applications and user preferences. The vertical barrier of the protective shield may be made from a range of materials, including plastic, wood, or fabric. The choice of material may depend on factors such as durability, weight, cost, and intended use.

For applications requiring flexibility, the vertical barrier may be constructed using disposable fabrics. These fabrics may allow for easy folding or collapsing of the shield for storage and transport. In some cases, disposable fabric barriers may be particularly useful in healthcare settings where frequent replacement of the barrier may be necessary for hygiene purposes.

In other cases, the vertical barrier may be made of hard rigid materials. These materials may provide enhanced durability and stability, which may be beneficial in scenarios where the protective shield may be subject to frequent use or potential impacts. Hard rigid materials may also offer improved protection against environmental factors such as wind or splashing liquids.

The vertical barrier may be designed to be either porous or non-porous, depending on the specific requirements of the application. A porous barrier may allow for some airflow between the guider and the person being guided, which may be desirable in certain situations. Conversely, a non-porous barrier may provide a more complete separation between individuals, which may be preferable in scenarios where minimizing potential transmission of airborne particles is a priority.

Similarly, the vertical barrier may be constructed to be either permeable or non-permeable. A permeable barrier may allow for some level of visibility or light transmission between the guider and the person being guided, which may enhance communication and situational awareness. A non-permeable barrier, on the other hand, may offer greater privacy or protection against visual distractions.

In some cases, the protective shield may be manufactured using injection molding techniques for plastic components. This method may allow for efficient production of complex shapes and integrated features such as handle attachments or folding mechanisms. For fabric-based barriers, cutting and sewing techniques may be employed to create the desired shape and incorporate any necessary reinforcements or attachment points.

For wooden components of the protective shield, such as handles or structural elements, traditional woodworking methods may be used. These may include cutting, shaping, and finishing processes to achieve the desired form and functionality.

In some implementations, the manufacturing process may involve a combination of techniques to produce a composite protective shield. For example, a rigid frame may be created using injection-molded plastic or shaped wood, while a flexible fabric barrier may be attached to this frame. This approach may allow for a balance of durability and flexibility in the final product.

The choice of materials and manufacturing methods for the protective shield may be influenced by factors such as cost, production volume, and specific performance requirements. In some cases, advanced materials or manufacturing techniques may be employed to enhance certain properties of the shield, such as antimicrobial coatings for improved hygiene or specialized polymers for increased durability.

The protective shield may incorporate various additional features and variations to enhance its functionality and adaptability to different use scenarios. In some cases, the vertical barrier of the protective shield may have varied colors, designs, and patterns. This customization may allow users to personalize their protective shields or distinguish between different shields in settings where multiple units are used. The colors, designs, and patterns may also serve functional purposes, such as improving visibility or indicating specific user roles or needs.

In some implementations, the protective shield may be integrated into a cane design. The protective shield may be in the form of a cane with a collapsible shield stored within the body of the cane handle. This configuration may allow users to have quick access to a protective barrier while maintaining the functionality of a traditional cane. The collapsible shield may be designed to extend from the cane handle when needed and retract for storage when not in use.

The protective shield may incorporate a pop-up umbrella component with a carry strap in some cases. This feature may allow for rapid deployment of the protective barrier, similar to opening an umbrella. The carry strap may facilitate easy transport of the shield when not in use. The pop-up mechanism may be designed to provide a stable and effective barrier when deployed while maintaining a compact form for storage.

In some implementations, the protective shield may be designed as a training cane for contactless orientation and mobility training sessions. This configuration may allow trainers to guide individuals with visual impairments or other mobility challenges while maintaining physical separation. The training cane may incorporate features such as adjustable length or tactile feedback mechanisms to enhance its effectiveness in orientation and mobility training scenarios.

The protective shield may be treated with antimicrobial solutions in some cases to enhance hygiene and reduce the risk of pathogen transmission. These treatments may be applied to the barrier surface, handles, or other components of the shield that may come into contact with users. The antimicrobial properties may help maintain cleanliness and potentially extend the usable life of the protective shield.

In some implementations, the protective shield may feature adjustable components to accommodate different user preferences or physical characteristics. For example, the height or width of the barrier may be adjustable to provide optimal coverage for users of varying sizes. Handles or straps may also be designed with adjustable features to ensure comfortable use across a range of body types.

The protective shield may be integrated with other forms of personal protective equipment in some cases. For example, the shield may be designed to attach to or work in conjunction with face masks, gloves, or protective clothing. This integration may provide a more comprehensive approach to personal protection in scenarios where multiple types of protective equipment may be beneficial.

In some implementations, the protective shield may incorporate visibility-enhancing features such as reflective materials or built-in lighting. These features may improve safety in low-light conditions or environments where high visibility may be important. The lighting may be battery-powered or rechargeable, with options for different light intensities or colors to suit various use scenarios.

The protective shield may be designed with modular components in some cases, allowing users to customize the configuration based on specific needs or preferences. For example, different types of handles, barriers, or attachment mechanisms may be interchangeable, providing flexibility in how the shield is used or worn.

In some implementations, the protective shield may incorporate sensors or electronic components to enhance functionality. For example, proximity sensors may be included to alert users when the recommended physical distance is not being maintained. These electronic features may be powered by replaceable or rechargeable batteries integrated into the shield design.

The protective shield may be constructed using eco-friendly or sustainable materials in some cases. This approach may include the use of recycled plastics, biodegradable components, or materials sourced from renewable resources. The use of sustainable materials may align with environmental concerns while maintaining the protective functionality of the shield.

In some implementations, the protective shield may be designed to fold or collapse into a compact form that can be easily carried in a pocket or small bag. This ultra-portable design may allow users to have a protective barrier readily available in various situations without the need for larger storage solutions.

The protective shield may incorporate temperature-regulating materials or designs in some cases. These features may help maintain comfort for users in different environmental conditions, potentially extending the duration for which the shield can be comfortably used.

In some implementations, the protective shield may be designed with specialized features for specific industries or use cases. For example, shields for healthcare settings may incorporate additional barrier layers or specialized materials to enhance protection against specific pathogens. Shields for industrial use may feature increased durability or resistance to certain chemicals or environmental factors.

A number of implementations have been described. Nevertheless, it will be understood that various modifications may be made without departing from the spirit and scope of the disclosure. Accordingly, other implementations are within the scope of the following claims.

I/We claim:

1. A protective shield comprising:
a barrier having a first major surface and a second major surface and configured to block contact between a guider and a person being guided;
a first handle attached to the first major surface and configured to be placed over the shoulder of the guider; and
a second handle attached to the second major surface and configured to be grasped by the person being guided.

2. The protective shield of claim 1, wherein the shield further comprises a rigid connection portion, wherein the first handle and the second handle are attached to opposite sides of the rigid connection portion.

3. The protective shield of claim 1, wherein the shield is a flexible shield.

4. The protective shield of claim 1, wherein the first handle and the second handle are detachable.

5. The protective shield of claim 1, wherein the second handle is an inverted handle configured to be grasped by the person being guided.

6. The protective shield of claim 1, wherein the barrier is transparent.

7. The protective shield of claim 1, wherein the first handle and the second handle are two portions of a single strap that slides through the barrier so that the strap acts as the handle for both the first surface of the barrier and the second surface of the barrier.

8. The protective shield of claim 7, wherein the single strap is adjustable in length.

9. The protective shield of claim 8, wherein the single strap comprises cushioning for enhanced grip and comfort.

10. A method of using a protective shield, comprising:
providing a barrier having a first major surface and a second major surface;
attaching a first handle to the first major surface;
attaching a second handle to the second major surface;
placing the first handle over the shoulder of a guider; and
allowing a person being guided to grasp the second handle, wherein the barrier is configured to block contact between the guider and the person being guided.

11. The method of claim 10, wherein the barrier is transparent.

12. The method of claim 10, wherein the first handle and the second handle are detachable.

13. The method of claim 12, further comprising detaching at least one of the first handle or the second handle when the protective shield is not in use.

14. The method of claim 10, wherein the barrier comprises a collapsible design.

15. The method of claim 14, wherein the collapsible design comprises a fan-like folding mechanism.

16. The method of claim 15, further comprising collapsing the barrier into a compact configuration for storage when not in use.

17. A protective shield system comprising:
a barrier having a first major surface and a second major surface and configured to block contact between a guider and a person being guided; and
a cuff attached to the barrier, wherein the cuff is configured to expand around the arm of the guider and positioned with respect to the barrier such that the person being guided grasps the cuff instead of grasping the guider's arm.

18. The protective shield system of claim 17, wherein the cuff is detachable from the barrier.

19. The protective shield system of claim 18, wherein the cuff is adjustable to accommodate different arm sizes.

20. The protective shield system of claim 19, wherein the cuff comprises padding on an inner surface to enhance comfort during extended wear.
